(19) United States
(12) Patent Application Publication
(10) Pub. No.: US 2003/0145140 A1
(43) Pub. Date: Jul. 31, 2003

(54) Method, apparatus, and system for processing data captured during exchanges between a server and a user

(76) Inventors: Christopher Straut, Duluth, GA (US); Albert S. Boyers, Atlanta, GA (US); Joseph H. Owen JR., Douglasville, GA (US); Ram Choragudi, Alpharetta, GA (US)

Correspondence Address: NEEDLE & ROSENBERG, P.C., The Candler Building, Suite 1200, 127 Peachtree Street, N.E., Atlanta, GA, 30303-1811, US

(21) Appl. No.: 10/061,489

(22) Filed: Jan. 31, 2002

(51) Int. Cl. G06F 13/00

(52) U.S. Cl. 710/33

(57) ABSTRACT

Data captured during at least one exchange between at least one server and at least one user is selectively processed. The captured data is retrieved, and a determination is made whether the retrieved data satisfies predefined rules. Data that satisfies the predefined rules is selected, and the selected data is recorded. The user may be a web browser or a web server, and the server may be a web server. The captured data may be in the form of an Internet protocol and is displayed to the user as a web page. Only a predetermined portion of the data is captured, e.g., a response or a request portion of the data. Image data associated with the captured data may be retrieved for displaying the web page to the user. Also, code module data associated with the captured data may be retrieved. Data captured during simultaneous exchanges between a plurality of servers and the user, the server and a plurality of users, or a plurality of servers and a plurality of users is processed.

### CROSS-REFERENCE TO RELATED APPLICATIONS

This application is related to commonly assigned U.S. Patent Applications entitled “Method, Apparatus, and System for Capturing Data Exchanged Between a Server and a User” and “Method, Apparatus, and System for Replaying Data Selected From Among Data Captured During Exchanges Between a Server and a User”, filed on or about the same day as the present application, and incorporated herein by reference.

### BACKGROUND

The present invention is directed to a method, apparatus, and system for processing captured data. More particularly, the present invention is directed to a method, apparatus, and system for processing data captured during an exchange between a server and a user.

For systems employing interactions between a user and server, it is often desirable to be able to view the interactions, ideally in a manner that is transparent to the user. This is particularly desirable in a context such as sales, customer service, and e-commerce, where interactions between customers and a service provider are important indicators of customer satisfaction.

Attempts have been made to recreate interactions between a user and a server. For example, click stream analysis procedures have been used to recreate interactions between a web user and a web service provider. This type of procedure is analogous to reviewing and analyzing the script to a movie. While this procedure reveals some information about the interaction between the server and the user, it does not provide a clear tangible picture of special effects, the environment, chemistry between the user and the server, etc.

Other attempts have been made to replay recorded interactions between a server and a user. However, these attempts are typically implemented at the server and are thus suitable only for a particular type of server. In addition, these approaches typically do not distinguish between interactions that are considered important and interactions that are not important. Thus, a lot of time and resources are wasted on replaying unimportant recorded interactions.

There is thus a need for a technique for selectively processing data captured during an exchange between a server and a user.

### SUMMARY

The present invention is directed to a method, apparatus and system for selectively processing data captured during at least one exchange between at least one server and at least one user.

According to exemplary embodiments, data captured during the exchange between the server and the user is retrieved. A determination is made whether the retrieved data satisfies predefined rules. Data that satisfies the predefined rules is selected, and the selected data is recorded.

According to one embodiment, the user is a web browser or a web server, and the server is a web server. The captured data may be pages, events, or attributes. The captured data may be in the form of an Internet protocol and is displayed to the user as a web page.

According to exemplary embodiment, only a predetermined portion of the data is captured, e.g., a response or a request portion of the data. Image data associated with the captured data may be retrieved for displaying the web page to the user. Also, code module data associated with the captured data may be retrieved.

According to exemplary embodiments, data captured during simultaneous exchanges between a plurality of servers and the user, the server and a plurality of users, or a plurality of servers and a plurality of users is processed.

Further objects, advantages and features of the present invention will become more apparent when reference is made to the following description taken in conjunction with the accompanying drawings.

### BRIEF DESCRIPTION OF THE DRAWINGS

FIG. 1A illustrates an exemplary implementation of the system for processing captured data according to an exemplary embodiment;

FIG. 1B illustrates in detail an exemplary system for processing captured data according to an exemplary embodiment;

FIGS. 2A-2C illustrate how data is stored according to exemplary embodiments;

FIGS. 3A and 3B illustrate exemplary page tables before and after post-processing, respectively; and

FIG. 4 illustrates an exemplary method for processing captured data according to an exemplary embodiment.

### DETAILED DESCRIPTION

According to exemplary embodiments, captured data exchanged between a server and a user is selectively processed. In the following description, the server is referred to as a web server, and the user is referred to as a web browser. It will be appreciated, however, that the invention may be applicable to other types of servers and users.

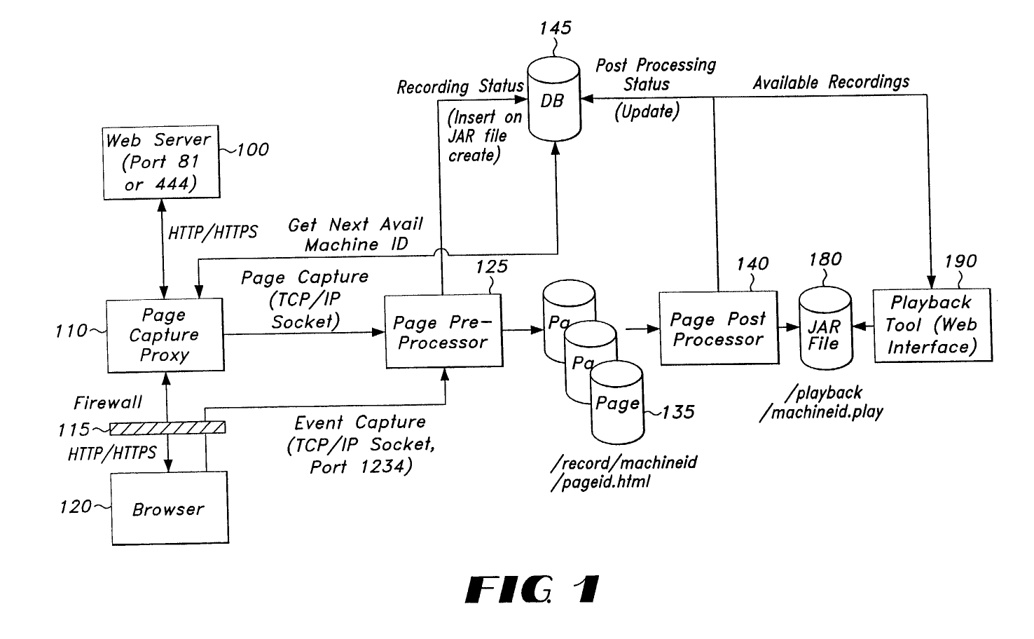

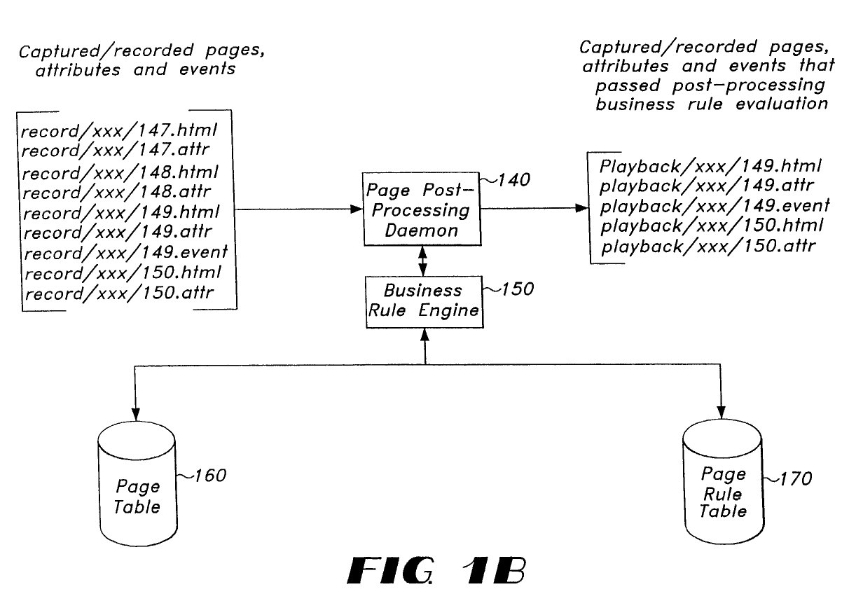

FIG. 1A illustrates an exemplary system for recording, capturing, and playing back interactions in which the invention may be implemented. The system includes a server, such as a web server 100, a data capturing module, such as a page capture module 110, and a user, such as a web browser 120. Although only one web server 100, page capture module 110, and web browser 120 are depicted in FIG. 1A, it will be appreciated that the invention is applicable to any number of servers, data capturing modules, and users.

The web browser 120 may be implemented in a personal computer, a telephone, etc. The web server 100 may be implemented as a server supporting any operating system, e.g., Unix, Linux, NT or Windows 2000.

The page capture module 110 is arranged between the web server 100 and the web browser 120. For security purposes, a firewall 115 may separate the web browser 120 and the page capture module 110.

The page capture module 110 operates independently from the web server 100 and the web browser 120. Thus, the page capture module 110 does not need to be customized for each type of web server but may be used with any web server, supporting any operating system.

Although the page capture module 110 operates independently from the web server 100 and the web browser, it may be implemented in the same device as the web server 100 or the web browser 120.

The page capture module 110 captures pages and other data exchanged between the web server 100 and the browser 120. Pages and other data may be captured continually or at designated intervals or time windows. The page capture module 110 may also record these pages and other data, or recording may be performed in a separate recorder server connected to the page capture module.

Each web browser 120 is assigned a unique machine identity (ID) by the web server 100. A persistent machine ID cookie may be created by the web server 110 and stored at the web browser 120 for this purpose. All pages served to a particular web browser 120 are identified and grouped by the machine ID.

Although the module 110 is described as a page capture module, according to exemplary embodiments, other types of data may also be captured. For example, events and attributes may be captured. Attributes may be captured in a manner similar to that in which pages are captured, as described above.

For event capturing, according to an exemplary embodiment an event capture module captures user side events and delivers these to the page capture module 110. The event capture module may be implemented as an applet 130 that is downloaded to the web browser 120. Although shown as a separate component, the event capture applet 130 is stored at the browser, with parameters such as the web browser machine ID, the host Internet Protocol (IP) address, and the current page name. The event capture applet 130 may be notified, for example, by JavaScript embedded in the current page, whenever an event needs to be recorded. The event capture applet 130 records events such as: page load, page unload, page scroll, page resize, and browser exit. The event capture applet 130 sends captured events to the page capturing module 110 via, for example, a Transmission Control Protocol/Internet Protocol (TCP/IP) socket connection on port 80 (or port 443 for secure exchanges).

Pages and other data captured during exchanges between the web server 100 and the web browser 120 at the page capture module 110 are sent from the page capturing module 110 to a page preprocessor 125 via, e.g., a TCP/IP socket.

According to an exemplary embodiment, each captured page is assigned a unique page ID and is associated with a specific browser user machine ID. Each page may also contain the date and time that the page was captured and the page status (recording, processing, playback, etc.) After pages are captured, this information is extracted from the captured page, and a new record is inserted into a database 145.

The page preprocessor 125 acts as a recorder server and stores the captured data in a device such as a database 145. The pages 135 are then passed on to the page post-processor 140. Alternatively, the page capturing module 110 may perform this recording. To reduce the amount of storage necessary, only predetermined portions of data may be stored, e.g., the request portion or the response portion. Also, only data satisfying predetermined rules, e.g., rules indicating timing, may be stored. When the captured pages are recorded, identifying information may also be recorded, e.g., a session record ID, a date/time of recording, a machine ID, etc.

An exemplary page capturing module and page preprocessor are described in more detail in the afore-mentioned application entitled “Method, Apparatus, and System for Capturing Data Exchanged Between a Server and a User”.

A post-processing module 140 determines which captured data satisfies predefined rules, e.g., business rules, and records this data in a file 180, such as a Java Archive (JAR) file. The database 145 is updated to indicate what captured data has been selected and recorded for playback. This is described in more detail below with reference to FIG. 1B.

A playback tool 190 selects recorded data from the database 180, using the information in the database 145. An exemplary playback tool is described in more detail in the afore-mentioned application entitled “Method, Apparatus, and System for Replaying Data Selected From Among Data Captured During Exchanges Between a Server and a User”.

Although not shown in the interest of simplifying the illustrations, it will be appreciated that the system in FIG. 1A may also include other components, e.g., configuration files used for processing.

FIG. 1B illustrates in detail an exemplary system for processing captured data according to an exemplary embodiment. Captured and recorded pages, attributes, and events are fed to a page post-processing program running on a page post-processor 140. A business rules engine 150 delivers business rules to the post-processor 140 that evaluates the captured/recorded pages to determine whether they satisfy the business rules. Data from a page table database 160 and a page rule table database 170 is used during this evaluation. Pages that satisfy the business rules are recorded for future playback. The page table and page rule database are updated after post-processing.

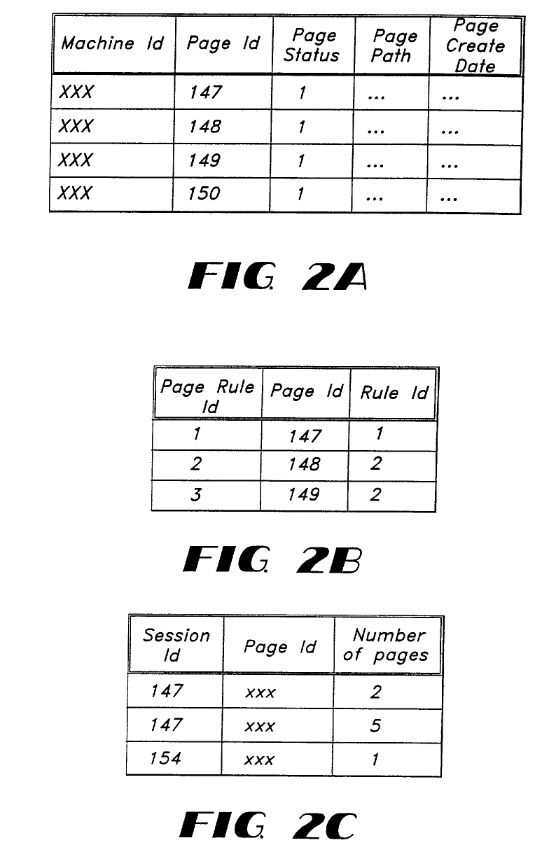

When a set of captured pages is identified as a session, then a session record is created of the identified session during post-processing. The session identification information may be stored in a session table, such as that shown in FIG. 2C.

According to exemplary embodiments, business rules are applied to the recorded data to determine whether a page should be saved for playback. Business rules are business elements that are compared with captured data in real time. An example of a comparison of business rule with captured data may be determining whether the captured data is an interaction resulting in a sale greater than a predetermined number of dollars, determining whether an interaction was longer than a predetermined number of minutes, etc. As another example, a business rule may state that the current page is to be recorded and all previous pages for that machine ID in that session.

According to an exemplary embodiments pages that do not satisfy the business rules are deleted.

According to an exemplary embodiment, the post-processing program appends the recorded JAR file to the playback JAR file in the playback directory for the current machine ID. If a playback file does not exist for the specified machine ID, the post-processing program may create one.

Images are retrieved for saved pages.

According to an exemplary embodiments, events may be recorded as a text file using XML. The file has the same name as the page that generated the event.

A time period may be set for retaining recorded data, e.g., 30 minutes. This time period may be used in determining whether a page is part of a session, and pages that are part of the same session may be grouped for future playback.

The tables of data shown in FIGS. 2A-2C demonstrate an example of how data is selected and stored for future playback according to an exemplary embodiment. Captured data is stored in a page table such as that shown in FIG. 2A. In FIG. 2A, each table entry includes a machine ID, a page ID, a page status, a page path, and a page create date. Data regarding rules is stored in a page rule table, as shown in FIG. 2B. Each entry the page rule table includes a page rule ID, a page ID and a rule ID. The page rule tables indicate which rule(s) were used to capture a specific page. The page rule table is updated as the result of evaluating pages in a session. Data concerning a session is stored in a sessions table, as shown in FIG. 2C. Each entry in the session table includes a session ID, a page ID and a number of pages.

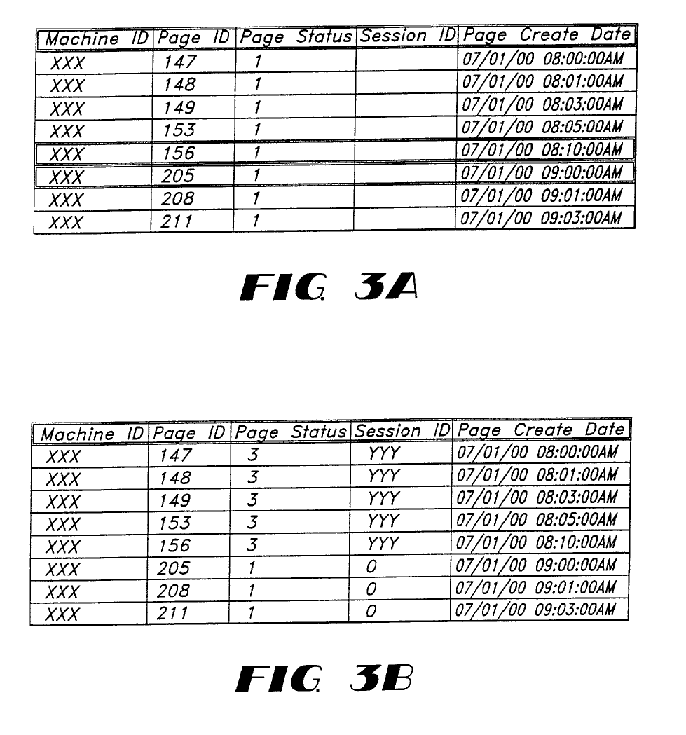

To demonstrate how data storing works, assume for example that the page table before post-processing appears as shown in FIG. 3A. Assume that a customer defined a maximum age limit of 30 minutes, and the current time at the time of page post-processing is 9:30:00 A.M. To identify an eligible session for page post-processing, a list of page table entries in which the machine ID equals xxx and page status equals 1 is selected and stored by page creation date. The list of matching pages is processed, and for each page, the current page creation date is compared to the previous page creation date. If the difference is greater than 30 minutes, then a session has been identified. To create a new session ID, the page ID for the first page in that session may be used. In this example, a session ID, yyy, has been generated. The session ID is stored in the session table, such as that shown in FIG. 2C.

Next, a determination is made whether the newly identified session is eligible for processing, using the page creation date for the last page in the session. If the page creation date for the last page in the session is greater than 30 minutes compared to the current time, then the session is eligible for post-processing. Otherwise, the session is not eligible at the current time, and the page status ID is reset back to 1.

For the last page entry in a list of page entries, a determination is made whether the last set of pages form a complete session and are therefore eligible for page post-processing.

After post-processing, the page table appears as shown in FIG. 3B.

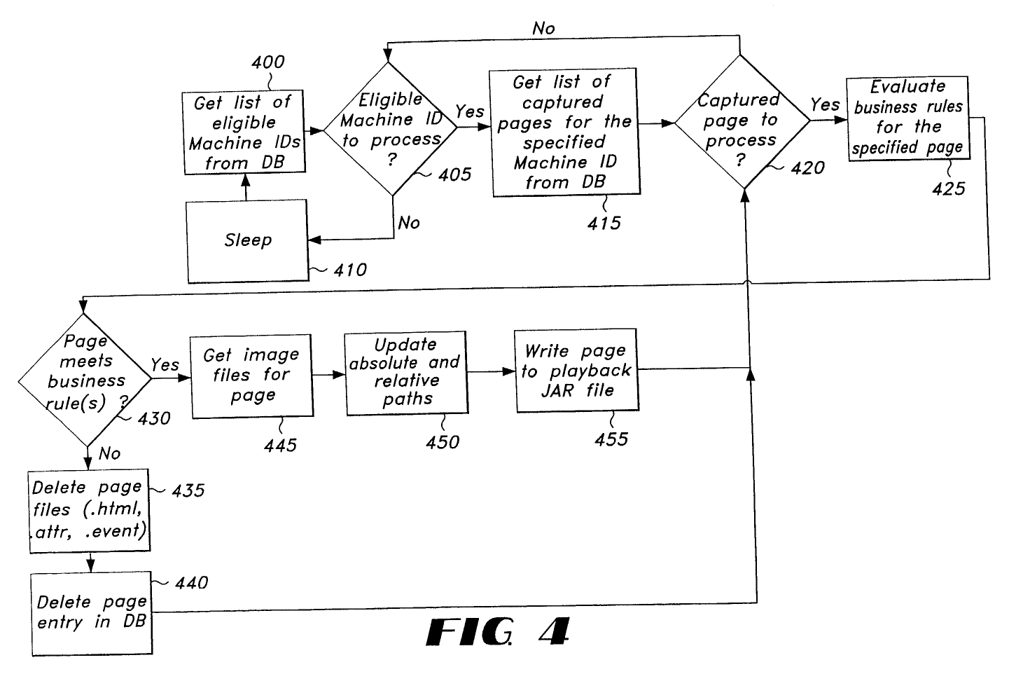

FIG. 4 illustrates an exemplary process for processing captured data according to an exemplary embodiment. The process begins at step 400 at which a list of eligible machine id's is retrieved from the database of stored captured data. At step 405, a determination is made whether the machine ID is eligible to proceed. In not, the process enters a sleep mode at step 410 and returns to step 400. If, at step 405, it is determined that there is an eligible machine ID to process, the list of captured pages from the specified machine ID is retrieved from the database at step 415. At step 420, a determination is made whether there is a captured page to process. If not, the process returns to step 405. If there is a captured page to process, business rules are evaluated for the specified page at step 425. These rules may be generated by the client. For example, the client may only want pages of a certain media recorded. At step 430, a determination is made whether the page satisfies the business rules. If not, the page files are deleted at step 435, the page entry ID selected from the database at step 440, and the process returns to step 420. If, at step 430, the page is determined to satisfy the business rules, the image files for the page are retrieved at step 445, the absolute and relative paths are updated at step 450, and the page is written to a playback file at step 455. From step 425, the process returns to step 430.

While the examples above discuss how captured pages are selectively recorded, the invention is not limited to selectively recording captured pages. According to exemplary embodiments, any type of data captured during an interaction between a user and a server may be selectively recorded. For example, events and attributes may be selectively recorded.

It should be understood that the foregoing description and accompanying drawings are by example only. A variety of modifications are envisioned that do not depart from the scope and spirit of the invention. The above description is intended by way of example only and is not intended to limit the present invention in any way.

What is claimed is:

1. A method for selectively processing data captured during at least one exchange between at least one server and at least one user, the method comprising the steps of:
retrieving data captured during the exchange between the server and the user;
determining whether the retrieved data satisfies predefined rules;
selecting the data that satisfies the predefined rules; and
recording the selected data.

2. The method of claim 1, wherein the selected data is recorded for a finite duration.

3. The method of claim 1, wherein the user is a web browser or a web server, and the server is a web server.

4. The method of claim 1, wherein the captured data includes at least one of pages, events, or attributes.

5. The method of claim 1, wherein the captured data is in the form of an Internet protocol and is displayed to the user as a web page.

6. The method of claim 5, wherein only a predetermined portion of the data is captured.

7. The method of claim 6, wherein only a response or a request portion of the data is captured.

8. The method of claim 7, further comprising retrieving image data associated with the captured data for displaying the web page to the user.

9. The method of claim 7, further comprising retrieving code module data associated with the captured data.

10. The method of claim 1, wherein the steps are performed for data captured during simultaneous exchanges between a plurality of servers and the user, the server and a plurality of users, or a plurality of servers and a plurality of users.

11. An apparatus for selectively processing data captured during at least one exchange between at least one server and at least one user, the apparatus comprising:
means for retrieving data captured during the exchange between the server and the user;
means for determining whether the retrieved data satisfies predefined rules;
means for selecting the data that satisfies the predefined rules; and means for recording the selected data.

12. The apparatus of claim 11, wherein the selected data is recorded for a finite duration.

13. The apparatus of claim 11, wherein the user is a web browser or a web server, and the server is a web server.

14. The apparatus of claim 11, wherein the captured data includes at least one of pages, events, or attributes.

15. The apparatus of claim 11, wherein the captured data is in the form of an Internet protocol and is displayed to the user as a web page.

16. The apparatus of claim 11, wherein only a portion of the data is captured.

17. The apparatus of claim 16, wherein only a request or a response portion of the data is captured.

18. The apparatus of claim 17, further comprising means for retrieving image data associated with the captured data for displaying the web page.

19. The apparatus of claim 17, further comprising means for retrieving code module data associated with the captured data.

20. The apparatus of claim 11, wherein data captured during exchanges between a plurality of servers and the user, the server and a plurality of users, or a plurality of users and a plurality of servers is selectively processed.

21. A system for selectively processing captured data, comprising:
at least one server;
at least one user; and
at least one processor for selectively processing data captured during an exchange between the server and the user, wherein the processor retrieves the captured data, determines whether the retrieved data satisfies predefined rules, selects the data that satisfies the predefined rules, and records the selected data.

22. The system of claim 21, wherein the selected data is recorded for a finite duration.

23. The system of claim 21, wherein the user is a web browser or a web server, and the server is a web server.

24. The system of claim 21, wherein the captured data includes at least one of pages, attributes, and events.

25. The system of claim 21, wherein the data is in the form of an Internet protocol and is used for displaying a web page to the user.

26. The system of claim 21, wherein only a predetermined portion of the data is captured.

27. The system of claim 26, wherein only a request or a response portion of the data is captured.

28. The system of claim 27, wherein the processor retrieves image data associated the captured data for displaying the web page to the user.

29. The system of claim 27, wherein the processor obtains code modules associated with the captured data.

30. The system of claim 21, wherein data captured during exchanges between a plurality of servers and the user, the server and a plurality of users, or a plurality of servers and a plurality of users is selectively processed.
